(19) United States
(12) Patent Application Publication
(10) Pub. No.: US 2025/0358620 A1
(43) Pub. Date: Nov. 20, 2025

(54) PRE-ASSOCIATION SECURITY NEGOTIATION (PASN) TUNNELING FOR PROTECTED UNAUTHENTICATED EXCHANGES

(71) Applicant: Cisco Technology, Inc., San Jose, CA (US)

(72) Inventors: Jerome Henry, Pittsboro, NC (US); Stephen Michael Orr, Wallkill, NY (US)

(21) Appl. No.: 19/094,071

(22) Filed: Mar. 28, 2025

Related U.S. Application Data
(60) Provisional application No. 63/649,111, filed on May 17, 2024.

(51) Int. Cl. H04W 12/61; H04W 12/033; H04W 12/0471; H04W 12/71

(52) U.S. Cl. CPC H04W 12/61; H04W 12/033; H04W 12/0471; H04W 12/71

(57) ABSTRACT

Presented herein are techniques to tunnel Pre-Association Security Negotiation (PASN) communications within another PASN protected exchange established with an (initial) access point (AP), thus allowing a station (STA) to establish one or more PASN sessions with one or more other access points (APs) through the initial AP, thereby enabling the STA to pre-establish PASN sessions with multiple APs without leaving its active channel with the initial AP. In at least embodiment, a method may include establishing a first PASN session between a STA and a first AP through initial PASN communications exchanged between the STA and the first AP and performing subsequent PASN communications between the STA and at least one other AP that are facilitated through the first PASN session established between the STA and the first AP to enable at least one subsequent PASN session to be established between the STA and the at least one other AP.

### PRIORITY CLAIM

This application claims the benefit of priority under 35 U.S.C. § 119 to U.S. Provisional Application No. 63/649,111, filed May 17, 2024, the entirety of which is incorporated herein by reference.

### TECHNICAL FIELD

The present disclosure relates to ranging exchanges used in wireless networks.

### BACKGROUND

In wireless local area networks (WLANs), such as Institute of Electrical and Electronics Engineering (IEEE) 802.11 wireless networks, unassociated exchanges are unprotected, unless a station (STA) establishes a Pre-Association Security Negotiation (PASN) exchange with an access point (AP). In a conventional PASN scenario, each side (A and B or STA and AP) provides a random ephemeral public key (A to B and B to A), that the other side uses to protect the traffic (B uses A's ephemeral public key to encrypt traffic sent to A, and vice versa). The exchange is protected and encrypted, but unauthenticated. That is, the STA has no proof that the AP is legitimate, irrespective of the Service Set Identifier (SSID) advertised by the AP; the AP has no information about the STA's identity.

In large networks, such reciprocal proof is not necessary for the AP side, because the STA usually queries for public information (e.g., ranging with Fine Time Measurement (FTM), learning potential services available through the AP obtained via Access Network Query Protocol (ANQP) exchanges, and/or Pre-Association Discovery [PAD]). However, the STA is interested in obtaining a valid response, i.e., information that would be consistent when provided by any legitimate AP within the Extended Service Set (ESS). Yet, there is no mechanism in the IEEE 802.11 standard to provide a good indication of that consistency. The STA can query all APs in the ESS but would have difficulty identifying AP impersonators beyond an analysis in outliers in the information provided. Such analysis is non-deterministic, not a Layer 2 (L2) function, and is compute consuming. Thus, there is an opportunity for a method that provides a simple consistency mechanism when information is provided by more than one AP.

### BRIEF DESCRIPTION OF THE DRAWINGS

FIG. 1 is a high-level block diagram of a system that may be implemented to facilitate Pre-Association Security Negotiation (PASN) tunneling for protected unauthenticated exchanges, according to an example embodiment.

FIG. 2A and 2B are a sequence diagram depicting example operations that can be performed via the system FIG. 1 in order to facilitate PASN tunneling for protected unauthenticated exchanges between a client device and one or more access points, according to an example embodiment.

FIG. 2C is a schematic diagram of a tunneled PASN element that can be utilized to facilitate PASN exchanges between a station (STA) and one or more neighboring access points through protected communications involving an initial access point with which the STA is communicating in accordance with embodiments herein.

FIG. 3 is a flow chart depicting a method according to an example embodiment.

FIG. 4 is another flow chart depicting another method according to an example embodiment.

FIG. 5 is another flow chart depicting another method according to an example embodiment.

FIG. 6 illustrates a hardware block diagram of a computing device that may perform the functions of a client device, a station, an access point and/or a wireless local area network controller (WLC) configured to perform functions associated with operations discussed in connection with embodiments herein.

### DESCRIPTION OF EXAMPLE EMBODIMENTS

### Overview

Presented herein are techniques to tunnel a pre-association security negotiation (PASN) authentication exchange between a client device or station (STA) with at least one second access point (APs) within another PASN protected exchange or PASN tunnel established with a first AP. This allows the client device to establish a PASN session with an AP (AP2) through another AP (AP1) with which a PASN tunnel has been established, thus allowing the client device to pre-establish PASN sessions with multiple APs without leaving its active channel (time saving) and also obtaining good indication that a number of APs are part of the same system, mobility domain, or Extended Service Set (ESS).

In at least one embodiment, a computer-implemented method is provided that may include establishing a first Pre-Association Security Negotiation (PASN) session between a client device and a first access point (AP) through initial PASN communications exchanged between the client device and the first AP; and performing subsequent PASN communications between the client device and at least one other AP that are facilitated through the first PASN session established between the client device and the first AP to enable at least one subsequent PASN session to be established between the client device and the at least one other AP.

In at least one embodiment, a computer-implemented method is provided that may include establishing a first PASN session between a client device and a first AP; transmitting, by the client device via the first PASN session, a PASN first frame to the first AP that includes a key of the client device, an indication that the first AP is to send elements of the PASN first frame to a second AP, and an identifier of the client device that the client device is to use for wireless communications with the second AP; and obtaining, by the client device from the first AP via the first PASN session, a PASN second frame that includes a key of the second AP, a message integrity code (MIC) associated with the second AP, and a timeout value for establishing a second PASN session between the client device and the second AP.

In at least one embodiment, a computer-implemented method is provided that may include establishing a first PASN session between a first AP and a client device; obtaining, by the first AP via the first PASN session, a PASN first frame from the client device, the PASN first frame comprising PASN first frame elements including a key of the client device, an indication that the first AP is to send the PASN first frame elements to a second AP, and an identifier of the client device that the client device is to use for wireless communications with the second AP; transmitting, by the first AP, the PASN first frame elements to the second AP based on the indication included in the PASN first frame; obtaining, by the first AP from the second AP, PASN second frame elements including a key of the second AP, a MIC associated with the second AP, and a timeout value; and transmitting a PASN second frame to the client device that includes the PASN second frame elements for establishing a second PASN session between the client device and the second AP.

### Example Embodiments

The Institute of Electrical and Electronics Engineers (IEEE) 802.11az-2022 specification, published 2023, improves Fine Timing Measurement (FTM) security by leveraging an encryption mode, called Pre-Association (or Preassociation) Security Negotiation (PASN), by which an unassociated client creates a secure session to an AP before performing ranging with that AP. PASN is implemented in 802.11az-2022 to limit the attack surface (exposure) of Fine Time Measurement (FTM) exchanges. PASN brings data exchange obfuscation, but no authentication. Other techniques may be employed to protect the exchanges between the client and AP and may suffer from the same or similar deficiencies of PASN with respect to authentication. In other words, with PASN or other similar techniques, although the link of the FTM exchanges is protected from injection and eavesdropping, the AP itself is not authenticated. This mode protects against spoofing attacks directed toward an active client-AP ranging session, however, this protection only somewhat mitigates the above problems associated with Global Positioning System (GPS) attacks. An attacker can still pretend to be a valid AP and perform the GPS attack, and an attacker can still spoof the MAC address of a valid AP and establish a new secure session with the client for the next ranging attempt. Once this has happened, the legitimate AP is the one appearing to be a rogue. An attacker can still insert into the FTM process and poison the user measurements.

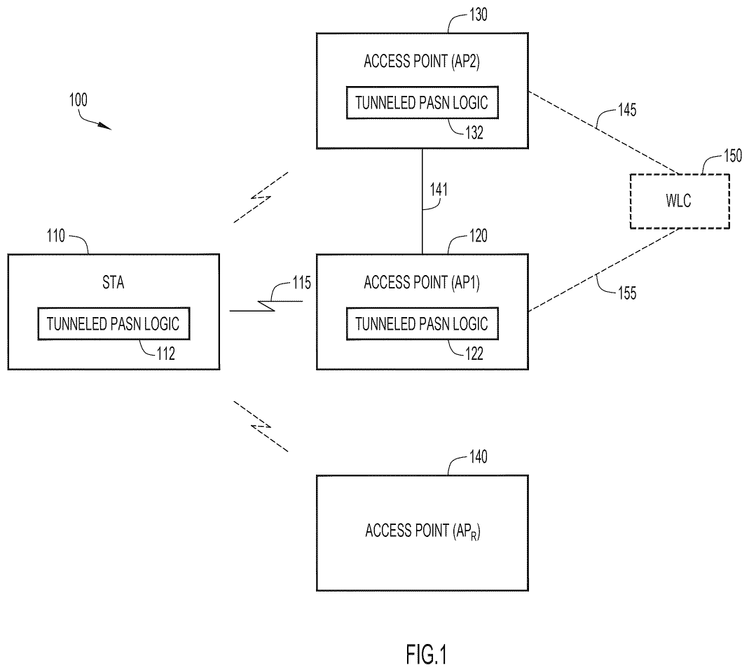

FIG. 1 is a high-level block diagram of a system that may be implemented to facilitate pre-association security negotiation (PASN) tunneling for protected unauthenticated exchanges, according to an example embodiment. The system 100 includes a client device or station (STA) 110 and a plurality of access points (APs). As shown in FIG. 1, the system 100 includes a first access point 120 (AP1) and a second access point 130 (AP2). A third access point 140 (shown as APR) may be an attacker or rogue AP. Also shown in FIG. 1 is a wireless local area network (LAN) controller (WLC) 150 that may be implemented in the system 100 in some embodiments. As generally shown in FIG. 1, STA 110 may communicate with the first access point 120 via a wireless communication link shown at 115.

In at least one embodiment, the STA 110 can be configured with tunneled PASN logic 112 and the second access point 130 can be configured with tunneled PASN logic 132 in order to perform operations in accordance with embodiments herein. In at least one embodiment, the first access point 120 can be configured with tunneled PASN logic 122 and the second access point 130 can be configured with tunneled PASN logic 132 in order to perform operations in accordance with embodiments herein.

In at least one embodiment, the first access point 120 and the second access point 130 may communicate directly with each other via a communication link 141 that may facilitate a distribution system (DS) that may include any number of wired and/or wireless communication link(s) that enable the first access point 120 and the second access point 130 to perform tunneled PASN communication exchanges (e.g., via operations performed via tunneled PASN logic 122 and 132) in accordance with embodiments herein.

A DS may be considered any AP-to-AP link that is visible at Layer 2 (meaning Media Access Control (MAC) addresses are visible). Thus, a DS can consist of a mesh link between 2 AP radios or, more commonly, a wired Ethernet (802.3) link between APs. To accommodate communication on such a DS, 802.11 designed 802.11F with a recommendation for a standard referred to as Inter AP Protocol (IAPP), through which APs can encapsulate in the other medium (e.g., 802.3) 802.11-related information to be exchanged.

In at least one embodiment, the WLC 150 may monitor and control the first access point 120 and the second access point 130. The WLC 150 may communicate with the first access point 120 and the second access point 130, respectively, via communication links shown at 145 and 155. For example, each of the communication links shown at 145 and 155 may include one or more wired or wireless connections that enables the WLC 150 to communicate information to the first access point 120 and the second access point 130, respectively. The WLC 150 may be configured to communicate with the first access point 120 and the second access point 130 and send to and/or receive from the first access point 120 and/or the second access point 130 various information. For example, in some embodiments tunneled PASN exchanged between the first access point and the second access point may be facilitated via WLC 150. Thus, any combination of DS-based AP-to-AP communications and/or AP-to-AP communications facilitated via WLC 150 may be utilized to facilitate AP-to-AP exchanges discussed for embodiments herein.

The STA 110 may be configured to communicate with access points and receive various information from the access points including, for example, location information and/or neighbor information relating to neighboring access points. For example, the STA 110 may receive from the first access point 120, first location information, first neighbor information relating to neighboring access points of the first access point, such as the second access point 130 being a neighboring access point and potentially the third access point 140 (e.g., rouge AP) being a neighboring access point.

With reference still to FIG. 1, a method may be provided to employ the logic of Fast Transition (FT) exchanges in PASN signaling schemes such that the STA 110 can establish a PASN tunnel with the first access point 120 and can thereafter initiate PASN exchanges with one or more other (neighboring) access points through the PASN tunnel established with the first access point. In this manner, the client device can initiate or establish a PASN session with a neighboring access point, such as the second access point 130 (and potentially other neighboring access points that belong to the same mobility domain as the first access point 120), through a PASN tunnel that the STA 110 establishes with the first access point 120, thus allowing the client device to pre-establish PASN sessions with multiple APs without leaving its active channel/PASN tunnel established with the first access point 120 and also obtaining good indication that a number of APs are part of the same mobility domain.

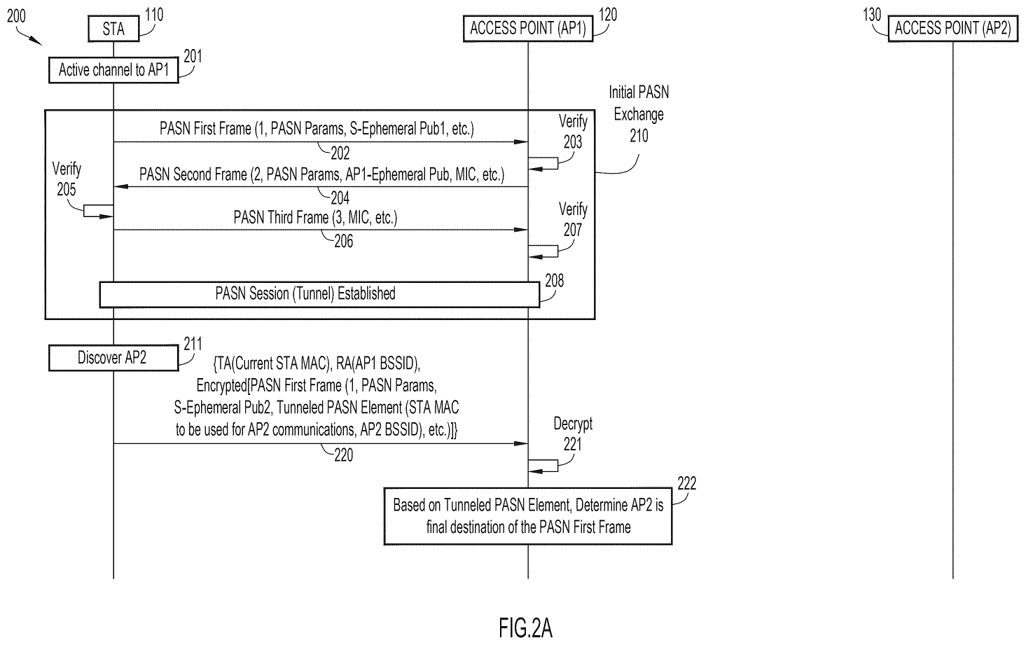

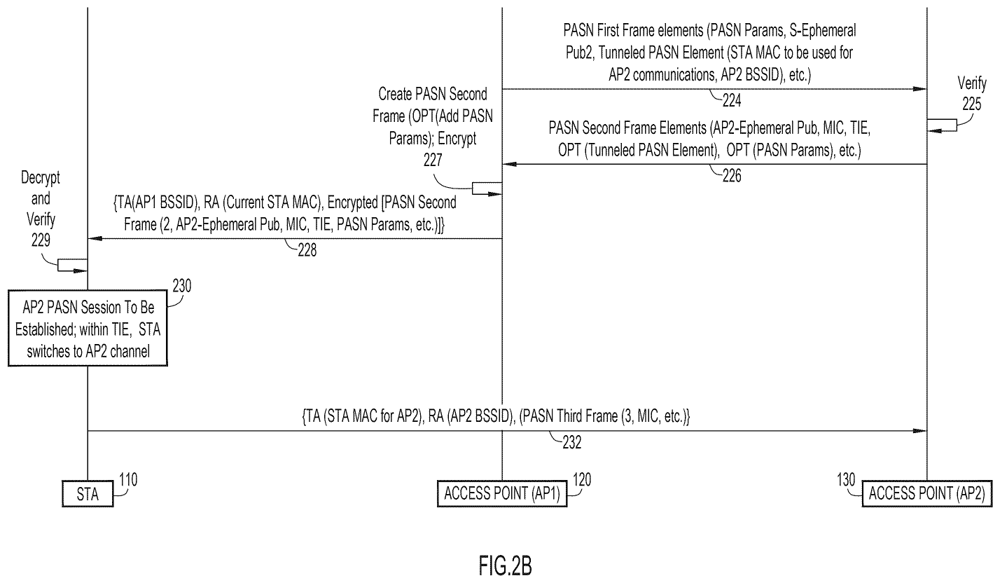

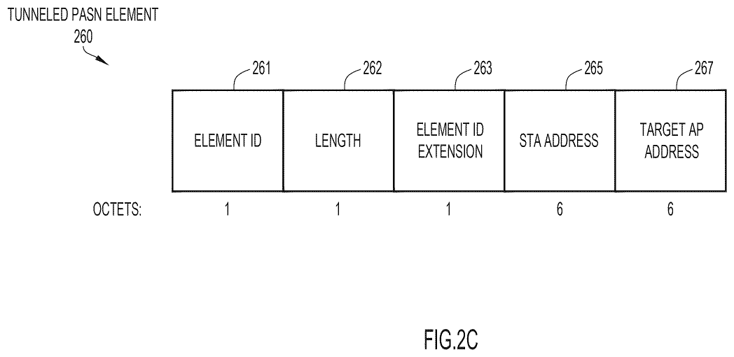

Referring to FIGS. 2A and 2B, FIGS. 2A and 2B are a sequence diagram 200 depicting example operations that can be performed via system 100 of FIG. 1 in order to facilitate PASN tunneling for protected unauthenticated exchanges between STA 110 and one or more second access points, such as second access point 130, according to an example embodiment. FIGS. 2A and 2B include STA 110, first access point 120 (referred to interchangeably herein as AP1), and second access point 130 (referred to interchangeably herein as AP2).

FIG. 2C is a schematic diagram of a tunneled PASN element 260 that can be utilized through unauthenticated exchanges with one or more (second) access points in accordance with embodiments herein and is discussed in conjunction with features of FIGS. 2A-2B.

As illustrated in FIG. 2A, it is assumed that the STA 110 has an active channel with the first access point 120 (AP1), as shown at 201, and establishes a PASN session or tunnel with the first access point 120, as generally shown at 208, through an initial PASN exchange 210 performed between the STA 110 and the first access point 120. The PASN session (208) established between the STA 110 and the first access point 120 can be referred to as an ‘initial’ PASN session involving the STA 110.

A PASN exchange, as defined per 802.11az-2022 between a client device or station, such as STA 110, and an access point, such as first access point 120, can refer to an exchange of at least an ephemeral public key of the STA with the access point performed via communication of a PASN first frame sent from the STA to the access point. The PASN exchange further includes exchange an ephemeral public key of the access point with the STA performed via communication of a PASN second frame sent from the access point to the STA. The PASN exchange further includes communication of a PASN third frame sent from the STA to the access point that involves the client device generating and sending a Message Integrity Code (MIC) (generated using the ephemeral public key of the access point, to indicate successful receipt the ephemeral public key of the access point). Other various parameters/information can be included in the PASN third frame that can be used for encrypted communications that can be exchanged between the STA and the access point via a secure tunnel established between the client device and the access point through the PASN exchanges.

Although the third PASN frame is defined per 802.11az-2022 for the completing tunnel/session establishment between a STA and an access point, embodiments herein may consider that at the end of processing a PASN second frame (validation/verification of the frame contents by the STA), the STA may consider the PASN session to be established with a given AP from the STA's perspective (because the STA has all that it needs to exchange protected communications with the given AP). However, the PASN session is not considered to be fully established with the given AP until the AP receives the PASN third frame from the STA and successfully validates/verifies the contents (e.g., the MIC) of the PASN third frame. In particular, for a subsequent access point (AP2) through which tunneled PASN communications are exchanged with a STA via an initial PASN session involving a first access point (AP1), upon receipt and validation/verification of a PASN second frame by the STA that is sent from the subsequent access point (AP2) through the first access point (AP1) to the STA via the initial PASN session, from the STA's perspective, the STA may consider a subsequent PASN session to be established with the subsequent access point (AP2). However, the subsequent PASN session is not considered to be fully established from the perspective of both the STA and subsequent access point until the STA sends a PASN third frame to the subsequent access point (AP2) and the subsequent access point successfully validates/verifies the contents of the PASN third frame.

In various embodiments, a PASN third frame for a subsequent PASN session involving a subsequent access point (AP2) can, within a timeout interval indicated by the subsequent access point (AP2), be communicated to the subsequent access point (AP2) either via tunneled PASN communications sent by the STA via the first access point (AP1) and the initial PASN session (e.g., to completely establish the PASN session with the subsequent access point before the STA switches its active RF channel) or via an over-the-air (OTA) wireless communication transmitted by the STA to the subsequent access point (AP2) after the STA switches its active RF channel to communicate with the subsequent access point.

With reference to FIG. 2A, for establishing the initial PASN session 208 with the first access point 120 (AP1), the STA 110 sends a PASN first frame to the first access point 120 (AP1), as shown at 202, that includes various PASN parameters of the STA 110 and an ephemeral public key of the STA 110 (shown in FIG. 2A as ‘S-Ephemeral Pub1’), as prescribed by 802.11az-2022, Section 12.13.3.2. The public key of a STA for a PASN exchange/session is considered to be ephemeral because the STA can generate a new public/private key pair at any time (e.g., one per AP, if desired) and store the identity of the device (e.g., an AP) to which the public key of the pair was provided. Upon obtaining data/information (traffic) obtained from the other device, the STA can decrypt the traffic using the private key of the key pair.

Upon obtaining the PASN first frame, first access point 120 (AP1) validates/verifies the contents of the PASN first frame, as generally shown at 203, stores the ephemeral public key of the STA 110 (S-Ephemeral Pub1) and generates a PASN second frame that is sent to the STA 110, as shown at 204. As prescribed by 802.11az-2022, Section 12.13.3.2, the PASN second frame includes various PASN parameters, an ephemeral public key of the first access point 120 (shown in FIG. 2A as ‘AP1-Ephemeral Pub’), and a Message Integrity Code (MIC) that is computed by the first access point 120 based on the ephemeral public key of the STA 110 (S-Ephemeral Pub1). The public key of an AP for a PASN exchange/session is considered to be ephemeral because the AP can generate a new public/private key pair at any time and store the identity of the device (e.g., a STA) to which the public key of the pair was provided. Upon obtaining data/information (traffic) obtained from the other device, the AP can decrypt the traffic using the private key of the key pair.

Upon obtaining the PASN second frame, the STA 110 validates/verifies the contents of the PASN second frame, such as verifying the MIC included in the PASN second frame using the ephemeral public key of the STA, as generally shown at 205, stores the ephemeral public key of the first access point 120 (AP1-Emphemeral Pub), and replies with a PASN third frame, as shown at 206. As prescribed by 802.11az-2022, Section 12.13.3.2, the STA 110 generates the PASN third frame includes various PASN parameters and a MIC that is generated by the STA 110 based on the ephemeral public key of the first access point 120 (AP-Ephemeral Pub).

As generally shown at 207, the first access point 120 (AP1) validates/verifies the contents of the PASN third frame, such as verifying the MIC included in the PASN third frame using the ephemeral public key of the first access point 120 (AP1) conclude the STA's legitimacy. Upon successful validation/verification of the PASN third frame, the secure or protected PASN session 208 is considered to be established between the STA 110 and the first access point 120 (AP1).

At some point, as generally shown at 211, the STA 110 can discover the second access point 130 (AP2) using known techniques, such as by performing radio frequency (RF) scanning, through IEEE 802.11k neighbor reports, any/or any other methods now known to persons of skill in the art and/or hereinafter developed.

Upon discovering the neighboring access point, second access point 130 (AP2), in accordance with embodiments herein, the STA 110 can, via tunneled PASN logic 112, initiate tunneled PASN exchanges with the second access point 130 (AP2) through the protected PASN session 208 established via the first access point 120 (AP1) in order to facilitate PASN session establishment with the second access point 130 (AP2).

For example, as shown at 220, the STA 110 can generate a PASN first frame that is sent to the first access point 120 (AP1) via the protected PASN session 208 in which the transmit address (TA) of the communication is a current Media Access Control (MAC) address of the STA 110 that the STA 110 is utilizing for communications with the first access point 120 (AP1) and the Receiver address (RA) is the Basic Service Set Identifier (BSSID) of the first access point 120 (i.e., the MAC address of the first access point 120). The PASN first frame sent by the STA 110 at 220 is encrypted using the ephemeral public key of the STA 110 (S-Ephemeral Pub1).

The (tunneled) PASN first frame sent at 220 can include an ephemeral public key of the STA 110 that may be the same or different than the ephemeral public key, S-Ephemeral-Pub1, that was sent to the first access point 120 (AP1) for establishment of the initial PASN session 208. Thus, the ephemeral public key included in the PASN first frame sent at 220 for establishing a (second) PASN session with the second access point 130 (AP2) is shown as ‘S-Ephemeral Pub2’, which may represent the ephemeral public key that the STA 110 intends to use for PASN communications with the second access point 130 (AP2)

The PASN first frame sent at 220 can also include various PASN elements, per 802.11az-2022 and, in accordance with embodiments herein, can further include an optional element, referred to herein as a ‘tunneled PASN element’ that includes various fields that the first access point 120 (AP1) can utilize to determine that it is not the final destination of the PASN first frame (sent at 220), but rather that the PASN first frame (sent at 220) is to be forwarded to the second access point 130 (AP2) for PASN session establishment between the STA 110 and the second access point 130 (AP2).

With reference to FIG. 2C, FIG. 2C is a schematic diagram illustrating various example details for a tunneled PASN element 260 that can be utilized to facilitate tunneled PASN exchanges between a STA and one or more neighboring access points (e.g., between STA 110 and the second access point 130) through protected communications involving an initial PASN session established with an initial access point (e.g., the first access point 120) with which the STA (e.g., STA 110) is communicating, in accordance with embodiments herein.

As illustrated in FIG. 2C, the tunneled PASN element 260 includes an element identifier (ID) field 261 (one octet), a length field 262 (one octet), an element ID extension field 263 (one octet), a STA address field 265 (6 octets), and a target AP address field 267 (6 octets).

The element ID field 261, the length field 262, and the element ID extension field 263 can be set to values as defined in 802.11az-2022, Section 9.4.2.1 (e.g., element ID=255, element ID extension=100). Length is set to the size of the payload such that, for the tunneled PASN element 260, the length can be set to 12 octets (i.e., 2 MAC addresses, 6 bytes each)

The STA address field 265 can be set to an identifier that the STA 110 intends to use when it communicates wirelessly with the second access point 130 (AP2). More specifically, the STA address field 265 can be set to a (future) MAC address of the STA 110 that the STA 110 intends to use when it communicates wirelessly with the second access point 130 (AP2). The MAC address that the STA 110 intends to use in wireless communications with the second access point (130) can be (and is likely) different from the current MAC address of the STA 110 that is identified in the TA for the PASN first frame sent to the first access point 120 (AP1).

One potential reason for identifying another MAC address to be used for communications with a subsequent access point is because the STA 110 is not associated to any access point at this time and likely wants to limit the opportunities for an observer to track the STA's activity.

Returning to the tunneled PASN element 260, the target AP address field 267 can be set to the BSSID of the second access point 130 (AP2) with which the STA 110 seeks to establish the subsequent PASN session. The BSSID of the second access point 130 (AP2 BSSID) is the MAC address of the second access point 130.

As shown at 221, the first access point 120 (AP1) can decrypt the encrypted PASN first frame using the ephemeral public key of the STA 110 associated with the initial PASN session 208, S-Ephemeral Pub1.

As shown at 222, the first access point 120 (AP1) can analyze the contents of the PASN first frame, specifically, the target AP address field 267 of the tunneled PASN element 260 that is set to the BSSID of the second access point 130 (AP2) in order to determine that AP1 is not the final destination of the PASN first frame, but rather that the second access point 130 (AP2) is the final destination of the PASN first frame. Thus, the first access point 120 (AP1) can determine at 222 the PASN first frame is to be forwarded to the second access point 130 (AP2) for PASN session establishment between the STA 110 and the second access point 130 (AP2).

Moving to FIG. 2B, as shown at 224, the first access point 120 (AP1) forwards elements of the PASN first frame, including at least the ephemeral public key of the STA 110, S-Ephemeral Pub2, and the tunneled PASN element to the second access point 130 (AP2) over the Distribution System (DS). In at least one embodiment, the first access point 120 (AP1) may also send the PASN parameters included in the PASN first frame to the second access point 130 (AP2) such that the first access point 120 (AP1) may send the entirety of the PASN first frame to the second access point 130 (AP2).

As shown at 225, the second access point 130 (AP2) receives the PASN first frame elements, validates/verifies the contents of the PASN first frame elements (e.g., to validate that it can parse the S-Ephemeral Pub2 key and to check if it already knows the (future) MAC address that the STA 110 intends to use with the second access point 130, in which case the second access point would need to update the public key for the STA 110 with the S-Ephemeral Pub2 key), stores the ephemeral public key of the STA 110 (S-Ephemeral Pub2), and generates (e.g., via tunneled PASN logic 132) various PASN second frame elements that are to be sent to the STA 110 (via the first access point 120).

In at least one embodiment, the PASN second frame elements generated or provided by the second access point 130 (AP2) may include an ephemeral public key of the second access point 130, such as ‘AP2-Ephemeral Pub’, a MIC generated using AP2-Ephemeral Pub, and a Timeout Interval Element (TIE) of type 1, including a corresponding timeout interval value. In various embodiments, the timeout interval could be set within a range between 2-3 minutes or could even be set to a large value, such as several years. In at least one embodiment, the PASN second frame elements may also include the tunneled PASN element with the STA address field 265 including the (future) MAC address that the STA 110 intends to use for communications with the second access point 130 (AP2) and the target AP address field 267 set to the BSSID of the second access point 130 (AP2).

In at least one embodiment, the PASN second frame elements generated by the second access point 130 (AP2) may be a full PASN second frame including the ephemeral public key of the second access point 130 ('AP2-Ephemeral Pub'), the MIC, the TIE, optionally the tunneled PSN element, and also various PASN parameters, etc. as prescribed by 802.11az-2022, Section 12.13.3.1.

As generally shown at 227, the first access point 120 (AP1) builds or creates a PASN second frame using the PASN second frame elements obtained from the second access point 130 (AP2), which may, in at least one embodiment, include generating PASN parameters for the PASN second frame (if not provided by the second access point 130), and encrypts the PASN second frame using the ephemeral public key of the first access point 120, AP1-Ephemeral Pub. The first access point 120 (AP1) may know the ephemeral public key and MAC address of the second access point 130 (AP2) and so may be able to generate PASN parameters for the PASN second frame if not provided by the second access point 130 (AP2).

If the second access point 130 (AP2) sent a full PASN second frame (including all PASN second frame elements) to the first access point 120 (AP1), then the first access point 120 may encrypt the PASN second frame, thereby acting as a relay for the PASN second frame exchange involving the second access point 130 (AP2).

As shown at 228, the first access point 120 (AP1) transmits the PASN second frame to the STA 110 via the initial PASN session. As generally shown at 229, the STA 110 can decrypt and verify the contents of the PASN second frame. The response from the first access point 120 (AP1) indicates to the STA 110 that the first access point 120 successfully exchanged PASN communications with the second access point 130 and, thus, that both access points are in the same Extended Service Set (ESS).

Broadly, the exchange of the PASN first frame (transmitted at 220) and the PASN second frame (transmitted at 228) between the STA 110 and the second access point 130 (AP2) can be referred to herein as ‘tunneled PASN’, which can be facilitated via tunneled communications facilitated via the initial PASN session established between the STA 110 and the first access point 120 (AP1).

As generally shown at 230, receipt and verification of the PASN second frame including the ephemeral public key of the second access point 130, AP2-Ephemeral Pub, may enable to the STA 110 to determine that a subsequent PASN session is to be established with the second access point 130 such that in at least one embodiment, within the timeout interval indicated by the TIE included in the PASN second frame, the STA 110 can switch its active channel to the second access point 130 (AP2) channel to complete the PASN session establishment with the second access point 130 (AP2). For example, as shown at 232, in at least one embodiment, the STA 110 can generate and send to the second access point 130 (AP2) a PASN third frame that includes a MIC value generated using the AP2-Ephemeral Pub in which the TA of the PASN third frame communication can be set to the MAC address that was previously indicated by the STA in the tunneled PASN element sent in the PASN first frame (at 220). Upon receipt of the PASN third frame, the second access point 130 (AP2) can verify/validate the MIC of the PASN third frame to conclude the STA's legitimacy such that the PASN session with the STA 110 can be considered to be completed from the both the STA's perspective and the second access point's perspective.

Thereafter, although not shown in FIGS. 2A-2B, the STA 110 can then use the ephemeral public key of the second access point 130, AP2-Ephemeral Pub (received from AP2 through AP1 at 228) to send protected messages to the second access point 130 via the PASN session established with the second access point 130. Obtaining a response to communications sent to the second access point 130 (AP2) enables the STA 110 to conclude on the legitimacy of its OTA wireless exchange with the second access point 130 (AP2).

Although the example of FIGS. 2A-2B illustrates the PASN third frame being sent OTA by the STA 110 at 232, in at least one embodiment, the PASN third frame could be tunneled to the second access point 130 (AP2) via similar tunneled PASN communications involving the first access point 120 (AP1) as described above for the first PASN frame (sent at 220). In such an embodiment, the STA can generate a PASN third frame to send to the first access point 120 (AP1) that includes a tunneled PASN element that includes the MAC address that the STA 110 intends to use for wireless PASN communications with the second access point 130 and includes the BSSID of the second access point 130 to indicate to the first access point 120 that the first access point is not intended to be the final destination of the PASN third frame, but rather that elements of the PASN third frame, specifically, the MIC included therein, are to be sent to the second access point 130. In this embodiment, the second access point 130 can verify the MIC to conclude the legitimacy of the STA 110. Thereafter, the STA 110 can send OTA PASN communications to the second access point 130 (in which the TA of the PASN communication can be set to the MAC address that was previously indicated by the STA 110 in the tunneled PASN element sent in the PASN first frame (at 220) and the PASN third frame) for the PASN session established with the second access point.

Accordingly, embodiments herein provide for the ability to tunnel a PASN authentication with at least one second AP (AP2) within another PASN protected exchange involving a first AP (AP1), thereby allowing a client device/STA to establish a PASN session with an AP (AP2) through another AP (AP1). Thus, embodiments herein may enable a client device/STA to pre-establish sessions with each of multiple other APs without leaving its active channel with a first AP, thereby facilitating time savings for PASN session establishment with the other APs that would otherwise be performed over-the-air per current 802.11az-2022 standards and also allowing the client device/STA to obtain good indication that all APs are part of the same system (ESS).

Consider, in another example, that STA 110 may also detect the presence of/discover the third access point 140 (APR) within the system of FIG. 1. In such an instance, the STA 110 could also attempt to perform tunneled PASN exchanges with the third access point 140 via the PASN session established with the first access point 120. For example, the STA 110 could send a PASN first frame (encrypted) to the first access point 120 that includes a tunneled PASN element including the STA address field set to a MAC address of the STA 110 that the STA 110 intends to use for wireless communications with the third access point 140 and also including the target AP address field set to the BSSID of the third access point 140.

However, in this example, because the third access point 140 is considered a rogue access point in the system of FIG. 1 and not part of the same ESS or mobility domain as the first access point 120, the first access point 120 is not able to communicate elements of the PASN first frame to the third access point 140 and the STA 110 may simply timeout the PASN attempt when a PASN second frame is not received within an expected time interval from sending the PASN first frame. By not receiving a PASN second frame including the ephemeral public key of the third access point 140, the STA 110 can determine that the third access point 140 is not part of the same ESS as the first access point 120. As the STA 110 attempts more PASN exchanges with other neighboring APs, the STA 110 may form groups of groups of APs that can communicate with each other (via DS or a WLC), with the expectation that the largest AP groups are likely to be legitimate groups. An attacker could theoretically deploy multiple rogue APs that can communicate with each other, but this would likely involve a small group of APs for a given area. Thus, a STA determining large AP groups belonging to the same ESS may enable the STA to determine the legitimacy of such large AP groups, as opposed to smaller, more disparate AP groups.

Embodiments herein may also be utilized in a Fast Transition (FT) scenario. In an FT scenario, a STA is already associated with one AP (AP1) and, of course, does not want to associate with another AP (AP2) just to exchange FTM frames. The tunneled PASN scheme provided through embodiments herein fulfills both the criteria for validating AP2, while also leveraging the current association of the STA (thus, the confirmation that if AP1, which identity the STA verified while associating, responds with data from AP2, then it can be confirmed not only that AP1 and AP2 are in the same ESS, as in the pure PASN case, but also that they are both legitimate).

When used with FT (e.g., as prescribed by IEEE 802.11r), PASN authentication is a Robust Security Network Association (RSNA) protocol and relies on an FT key hierarchy already being established via the FT initial mobility domain association, as prescribed by 802.11az-2022, Section 13.4.2 (FT initial mobility domain association in an RSN). In accordance with embodiments herein, when implemented in an FT deployment, PASN protocol messages may carry the PMKROName (Pairwise Master Key RO Name) and the PASN PTKSA (Pairwise Transient Key Security Association) can be established similar to any other Base AKMP (Authentication and Key Management Protocol) procedure. In various instances, a Wrapped Data element may be optionally present in the PASN first frame, in addition to the tunneled PASN element. When the Wrapped Data element is not present in a PASN first frame, the PASN authentication is considered to be non-FT PASN. When the Wrapped Data element is present in a PASN first frame, the authentication is considered to be FT PASN.

The Wrapped Data element may include a set of elements, such as RSNE (i.e., Robust Security Network Element, as prescribed by 802.11az-2022, Section 9.4.2.23), MDE (i.e., Mobility Domain Element, as prescribed by 802.11az-2022, Section 9.4.2.45, such as MDE(#1776)), and FTE (i.e., Fast BSS Transition Element, as prescribed by 802.11az-2022, Section 9.4.2.46, such as (FTE#1776)). The Wrapped Data element may optionally be present in the PASN second frame but is to be present if the Wrapped Data element was present in the PASN first frame. When present in the PASN second frame, the Wrapped Data element is to include the RSNE, the MDE (e.g., MDE(#1776)), and the FTE (e.g., FTE(#1776)) as specified for the second message of the FT authentication sequence per 802.11az-2022, Section 13.8.3 (FT authentication sequence: contents of second message). The Wrapped Data element is to be absent in the PASN third frame. The elements in the Wrapped Data element are used for additional validation FT security parameters as being used in PASN authentication.

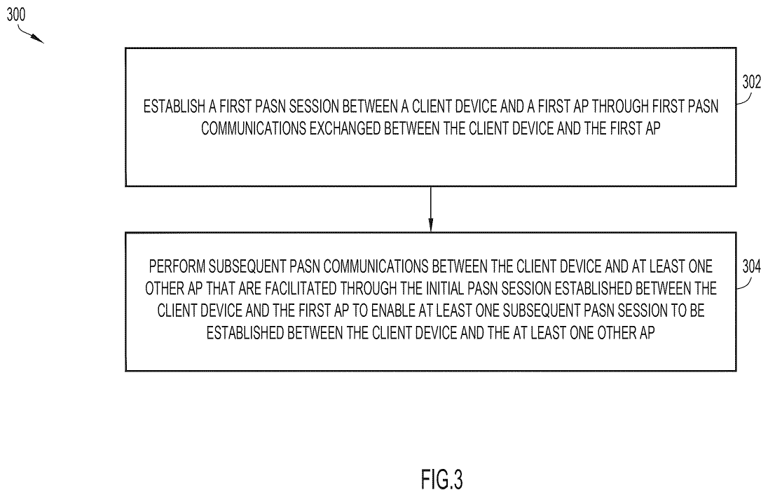

Referring to FIG. 3, FIG. 3 is a flow chart depicting a method 300 according to an example embodiment. In at least one embodiment, method 300 can be associated with tunnelling PASN communications involving at least one second access point within another PASN protected exchange established with a first AP, thus allowing a STA to establish one or more subsequent PASN sessions with one or more other access points through the first AP (e.g., through a first PASN session established with the first AP). In at least one embodiment, method 300 can be performed via a client device (e.g., STA 110), a first access point (e.g., first access point 120), and at least one other access point (e.g., second access point 130).

As illustrated at 302, the method may include establishing a first PASN session between a client device and a first AP through first PASN communications exchanged between the client device and the first AP (e.g., PASN session 208 established via the initial PASN exchange 210 of FIG. 2A).

As illustrated at 304, the method may include performing subsequent PASN communications between the client device and at least one other AP that are facilitated through the first PASN session established between the client device and the first AP to enable at least one subsequent PASN session to be established between the client device and the at least one other AP

In at least one embodiment, the subsequent PASN communications may include communicating a PASN first frame to the first AP by the client device (encrypted per the first PASN session ephemeral public key of the client device) that includes a tunneled PASN element that indicates to the first AP that it is not the destination of elements of the PASN first frame, but rather that the elements of the PASN first frame (e.g., an ephemeral public key of the client device and the tunneled PASN element) are to be sent to the at least one other AP (e.g., AP2). Thus, in at least one instance, performing the subsequent PASN communications includes obtaining, by the first AP, a first PASN frame (encrypted per the first PASN session ephemeral public key of the client device) that includes an indication that causes the first AP to identify the at least one other AP that is to be involved in the subsequent PASN communications. In at least one instance, the indication may be BSSID of the at least one other AP that is identified in the PASN first frame (e.g., via a tunneled PASN element included in the PASN first frame).

In at least one instance, the PASN first frame obtained by the first AP from the client device further includes an identifier of the client device that the client device is to use for wireless communications with the at least one other AP (e.g., via the tunneled PASN element included in the PASN first frame). In at least one instance, the identifier of the client device that the client device is to use for wireless communications with the at least one other AP is a MAC address that the client device is to use for wireless communications with the at least one other AP.

In at least one instance, performing the subsequent PASN communications may include communicating a PASN second frame to the client device from the first AP (encrypted per the first PASN session ephemeral public key of the first AP) that includes an ephemeral public key of the at least one other AP, a MIC associated with the at least one other AP, and a timeout value.

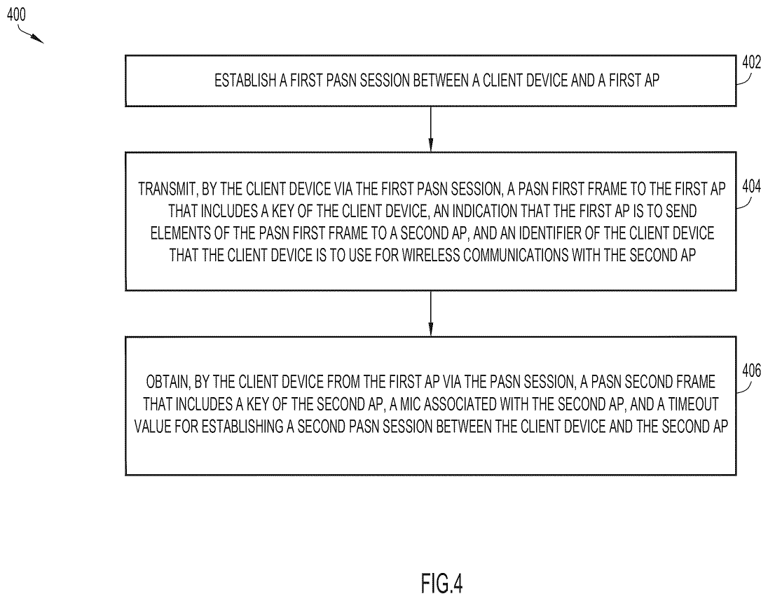

Referring to FIG. 4, FIG. 4 is a flow chart depicting a method 400 according to an example embodiment. In at least one embodiment, method 400 can be associated with tunnelling PASN communications involving at least one second access point within another PASN protected exchange established with a first AP, thus allowing a STA to establish one or more subsequent PASN sessions with one or more other access points through the first AP (e.g., through a first PASN session established with the first AP). In at least one embodiment, method 400 can be performed at least in part by a client device (e.g., STA 110). The method 400 may include communications involving a first access point (e.g., first access point 120) and a second access point (e.g., second access point 130).

As shown at 402, the method may include establishing a first PASN session between a client device and a first AP (e.g., PASN session 208 established via the initial PASN exchange 210 of FIG. 2A).

As shown at 404, the method may include transmitting, by the client device via the first PASN session, a PASN first frame to the first AP that includes a key of the client device, an indication that the first AP is to send elements of the PASN first frame to a second AP, and an identifier of the client device that the client device is to use for wireless communications with the second AP (e.g., as shown at 220 of FIG. 2A). In at least one instance, the transmitting may be performed upon the client device detecting or determining the presence of the second AP.

In at least one instance, the client device utilizes a first MAC address for establishing the first PASN session between the client device and the first AP and the identifier of the client device included in the PASN first frame is a second MAC address of the client device that is different than the first MAC address. In at least one instance, the first PASN session established between the client device and the first AP utilizes a first ephemeral public key of the client device and the key of the client device included in PASN first frame is a second ephemeral public key that is different than the first ephemeral public key of the client device.

In at least one instance, the indication that the first AP is to send the elements of the PASN first frame to the second AP and the identifier of the client device that the client device is to use for wireless communications with the second AP are included in a data element (e.g., a tunneled PASN element) included in the PASN first frame.

In at least one instance, the indication that the first AP is to send the elements of the PASN first frame to the second AP is a BSSID of the second AP that is identified in the data element and the identifier of the client device that the client device is to use for wireless communications with the second AP is a MAC address that the client device is to use for wireless communications with the second AP in which the MAC address identified in the data element.

In at least one instance, the indication that the first AP is to send the elements of the PASN first frame to the second AP is a BSSID of the second AP that is identified in 6 octets of the data element and the identifier of the client device that the client device is to use for wireless communications with the second AP is a MAC address that the client device is to use for wireless communications with the second AP in which the MAC address is identified in another 6 octets of the data element.

As shown at 406, the method may include obtaining, by the client device from the first AP via the first PASN session, a PASN second frame that includes a key of the second AP, a MIC associated with the second AP, and a timeout value for establishing a second PASN session between the client device and the second AP (e.g., as shown at 228 and 232 of FIG. 2B).

In at least one instance, although not shown in FIG. 4, the method may include within a timeout interval indicated by the timeout value, transmitting, by the client device a PASN third frame to the second AP that includes a MIC associated with the client device, in which transmit address for transmitting the PASN first frame is set to the identifier of the client device that was included in the PASN first frame. In at least one instance, the client device utilizes a first MAC address for establishing the first PASN session between the client device and the first AP and the identifier of the client device is a second MAC address of the client device that is different than the first MAC address that is used for establishing the second PASN session.

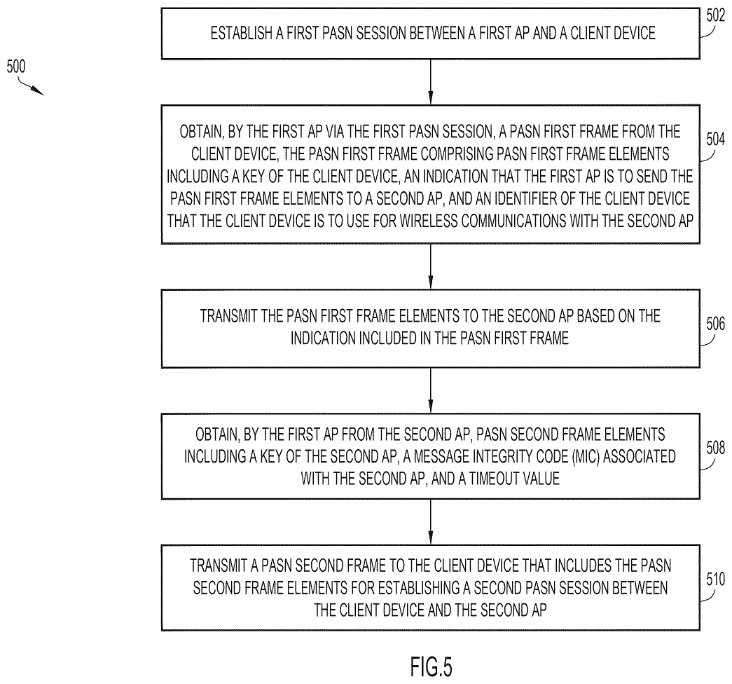

Referring to FIG. 5, FIG. 5 is a flow chart depicting a method 500 according to an example embodiment. In at least one embodiment, method 500 can be associated with tunnelling PASN communications involving at least one second access point within another PASN protected exchange established with a first AP, thus allowing a STA to establish one or more subsequent PASN sessions with one or more other access points through the first AP (e.g., through a first PASN session established with the first AP). In at least one embodiment, method 500 can be performed at least in part by a first access point (e.g., access point 120). The method 500 may include communications involving a client device (e.g., STA 110) and a second access point (e.g., second access point 130).

As shown at 502, the method may include establishing a first PASN session between a first AP and a client device (e.g., PASN session 208 established via the initial PASN exchange 210 of FIG. 2A).

As shown at 504, the method may include obtaining, by the first AP via the first PASN session, a PASN first frame from the client device, the PASN first frame comprising PASN first frame elements including a key of the client device, an indication that the first AP is to send the PASN first frame elements to a second AP, and an identifier of the client device that the client device is to use for wireless communications with the second AP (e.g., as shown at 220 of FIG. 2A).

In at least one instance, the indication that the first AP is to send the PASN first frame elements to the second AP and the identifier of the client device that the client device is to use for wireless communications with the second AP are included in a data element (e.g., a tunneled PASN element) for the PASN first frame. In at least one instance, the indication that the first AP is to send the PASN first frame elements to the second AP is a BSSID of the second AP that is identified in the data element and the identifier of the client device that the client device is to use for wireless communications with the second AP is a MAC address that the client device is to use for wireless communications with the second AP in which the MAC address identified in the data element.

As shown at 506, the method may include transmitting, by the first AP, the PASN first frame elements to the second AP based on the indication included in the PASN first frame (e.g., as shown at 222 and 224 of FIGS. 2A-2B). Communications between the first AP and the second AP can be performed via a DS or via WLC communications.

As shown at 508, the method may include obtaining, by the first AP from the second AP, PASN second frame elements including a key of the second AP, a message integrity code (MIC) associated with the second AP, and a timeout value (e.g., as shown at 226 of FIG. 2B)

As shown at 510, the method may include transmitting a PASN second frame to the client device (via the first PASN session) that includes the PASN second frame elements to enable another PASN session to be established between the client device and the second AP (e.g., as shown at 228 and 232 of FIG. 2B). The method may include encrypting, by the first AP, the PASN second frame using a key of the first AP provided to the client device through establishing the first PASN session between the first AP and the client device.

Although not shown in FIG. 5, the client device can complete establishment of the second PASN session with the second AP by sending a PASN third frame to the second AP that includes at least a MIC associated with the client device. The PASN third frame can be sent OTA to the second AP or can be sent to the first AP, which can communicate the PASN third frame (or the relevant elements thereof) to the second AP.

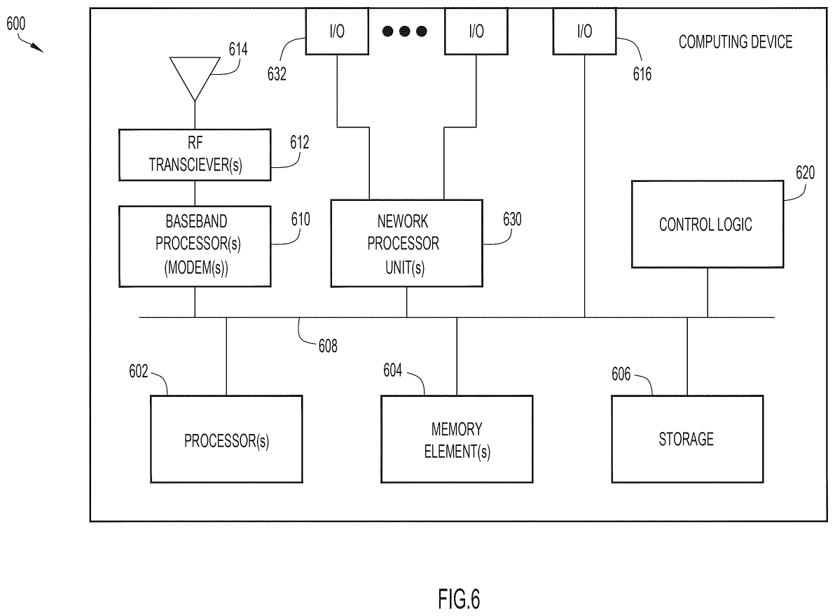

Referring to FIG. 6, FIG. 6 illustrates a hardware block diagram of a computing device 600 that may perform functions associated with operations discussed herein in connection with the embodiments herein. In various embodiments, a computing device or apparatus, such as computing device 600 or any combination of computing devices 600, may be configured as any entity/entities in order to perform operations of the various techniques discussed for embodiments herein, such as any elements, functions, etc. discussed for embodiments herein (e.g., STA 110, first access point 120, second access point 130, etc.).

In at least one embodiment, the computing device 600 may be any apparatus that may include one or more processor(s) 602, one or more memory element(s) 604, storage 606, a bus 608, one or more network processor unit(s) 630 interconnected with one or more network input/output (I/O) interface(s) 632, one or more I/O interface(s) 616, and control logic 620. In various embodiments, instructions associated with logic for computing device 600 can overlap in any manner and are not limited to the specific allocation of instructions and/or operations described herein.

Computing device 600 may further include at least one baseband processor or modem 610, one or more radio RF transceiver(s) 612 (e.g., any combination of RF receiver(s) and RF transmitter(s)), one or more antenna(s) or antenna array(s) 614 (which may be inclusive of software-defined antenna(s) or antenna array(s)).

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa) or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 630 may enable communication between computing device 600 and other systems, entities, etc., via network I/O interface(s) 632 (wired and/or wireless) to facilitate operations discussed for various embodiments described herein. In various embodiments, network processor unit(s) 630 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 632 can be configured as one or more Ethernet port(s), Fibre Channel ports, any other I/O port(s), and/or antenna(s)/antenna array(s) now known or hereafter developed. Thus, the network processor unit(s) 630 and/or network I/O interface(s) 632 may include suitable interfaces for receiving, transmitting, and/or otherwise communicating data and/or information (wired and/or wirelessly) in a network environment.

I/O interface(s) 616 allow for input and output of data and/or information with other entities that may be connected to computing device 600. For example, I/O interface(s) 616 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 612 may perform RF transmission and RF reception of wireless signals via antenna(s)/antenna array(s) 614, and the baseband processor or modem 610 performs baseband modulation and demodulation, etc. associated with such signals to enable wireless communications for computing device 600.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include establishing a first Pre-Association Security Negotiation (PASN) session between a client device and a first access point (AP) through initial PASN communications exchanged between the client device and the first AP; and performing subsequent PASN communications between the client device and at least one other AP that are facilitated through the first PASN session established between the client device and the first AP to enable at least one subsequent PASN session to be established between the client device and the at least one other AP.

In one instance, the method may further include performing the subsequent PASN communications includes obtaining, by the first AP, a first PASN frame that includes an indication that causes the first AP to identify the at least one other AP that is to be involved in the subsequent PASN communications.

In one instance, the indication is a Basic Service Set Identifier (BSSID) of the at least one other AP that is identified in the PASN first frame.

In one instance, the PASN first frame obtained by the first AP from the client device further includes an identifier of the client device that the client device is to use for wireless communications with the at least one other AP.

In one instance, the identifier of the client device that the client device is to use for wireless communications with the at least one other AP is a Media Access Control (MAC) address that the client device is to use for wireless communications with the at least one other AP.

In one instance, performing the subsequent PASN communications includes communicating a PASN second frame to the client device from the first AP that includes an ephemeral public key of the at least one other AP, a Message Integrity Code (MIC) associated with the at least one other AP, and a timeout value.

In one form, a computer-implemented method is provided that may include establishing a first PASN session between a client device and a first AP; transmitting, by the client device via the first PASN session, a PASN first frame to the first AP that includes a key of the client device, an indication that the first AP is to send elements of the PASN first frame to a second AP, and an identifier of the client device that the client device is to use for wireless communications with the second AP; and obtaining, by the client device from the first AP via the first PASN session, a PASN second frame that includes a key of the second AP, a message integrity code (MIC) associated with the second AP, and a timeout value for establishing a second PASN session between the client device and the second AP.

In one instance, the method may further include, within a time interval indicated by the timeout value, transmitting, by the client device a PASN third frame to the second AP to establish the second PASN session with the second AP, wherein the PASN third frame includes a MIC associated with the client device, in which a transmit address for transmitting the PASN first frame is set to the identifier of the client device that was included in the PASN first frame.

In one instance, the identifier of the client device is a media access control (MAC) address of the client device.

In one instance, the client device utilizes a first media access control (MAC) address for establishing the first PASN session between the client device and the first AP and the identifier of the client device is a second MAC address of the client device that is different than the first MAC address.

In one instance, the first PASN session established between the client device and the first AP utilizes a first key of the client device and the key of the client device included in PASN first frame is a second key that is different than the first key.

In one instance, the indication that the first AP is to send the elements of the PASN first frame to the second AP and the identifier of the client device that the client device is to use for wireless communications with the second AP are included in a data element for the PASN first frame.

In one instance, the indication that the first AP is to send the elements of the PASN first frame to the second AP is a Basic Service Set Identifier (BSSID) of the second AP that is identified in the data element and the identifier of the client device that the client device is to use for wireless communications with the second AP is a media access control (MAC) address that the client device is to use for wireless communications with the second AP in which the MAC address identified in the data element.

In one instance, the indication that the first AP is to send the elements of the PASN first frame to the second AP is a Basic Service Set Identifier (BSSID) of the second AP that is identified in 6 octets of the data element and the identifier of the client device that the client device is to use for wireless communications with the second AP is a media access control (MAC) address that the client device is to use for wireless communications with the second AP in which the MAC address is identified in another 6 octets of the data element.

In one instance, the method may include encrypting the PASN first frame by the client device using a key of the client device provided to the first AP through establishing the first PASN session between the client device and the first AP.

In one instance, the PASN second frame obtained by the client device is encrypted using a key of the first AP provided to the client device through establishing the first PASN session between the client device and the first AP.

In one form, a computer-implemented method is provided that may include establishing a first PASN session between a first AP and a client device; obtaining, by the first AP via the first PASN session, a PASN first frame from the client device, the PASN first frame comprising PASN first frame elements including a key of the client device, an indication that the first AP is to send the PASN first frame elements to a second AP, and an identifier of the client device that the client device is to use for wireless communications with the second AP; transmitting, by the first AP, the PASN first frame elements to the second AP based on the indication included in the PASN first frame; obtaining, by the first AP from the second AP, PASN second frame elements including a key of the second AP, a MIC associated with the second AP, and a timeout value; and transmitting a PASN second frame to the client device (via the first PASN session) that includes the PASN second frame elements for establishing a second PASN session between the client device and the second AP.

In one instance, the indication that the first AP is to send the PASN first frame elements to the second AP and the identifier of the client device that the client device is to use for wireless communications with the second AP are included in a data element for the PASN first frame.

In one instance, the indication that the first AP is to send the PASN first frame elements to the second AP is a Basic Service Set Identifier (BSSID) of the second AP that is identified in the data element and the identifier of the client device that the client device is to use for wireless communications with the second AP is a media access control (MAC) address that the client device is to use for wireless communications with the second AP in which the MAC address identified in the data element.

In one instance, the method may further include encrypting, by the first AP, the PASN second frame using a key of the first AP provided to the client device through establishing the first PASN session between the first AP and the client device.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination or receiver address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
establishing a first Pre-Association Security Negotiation (PASN) session between a client device and a first access point (AP);
transmitting, by the client device via the first PASN session, a PASN first frame to the first AP that includes a key of the client device, an indication that the first AP is to send elements of the PASN first frame to a second AP, and an identifier of the client device that the client device is to use for wireless communications with the second AP; and
obtaining, by the client device from the first AP via the first PASN session, a PASN second frame that includes a key of the second AP, a message integrity code (MIC) associated with the second AP, and a timeout value for establishing a second PASN session between the client device and the second AP.

2. The method of claim 1, further comprising:
within a time interval indicated by the timeout value, transmitting, by the client device a PASN third frame to the second AP to establish the second PASN session with the second AP, wherein the PASN third frame includes a MIC associated with the client device, in which a transmit address for transmitting the PASN first frame is set to the identifier of the client device that was included in the PASN first frame.

3. The method of claim 2, wherein the identifier of the client device is a media access control (MAC) address of the client device.

4. The method of claim 2, wherein the client device utilizes a first media access control (MAC) address for establishing the first PASN session between the client device and the first AP and the identifier of the client device is a second MAC address of the client device that is different than the first MAC address.

5. The method of claim 1, wherein the first PASN session established between the client device and the first AP utilizes a first key of the client device and the key of the client device included in PASN first frame is a second key that is different than the first key.

6. The method of claim 1, wherein the indication that the first AP is to send the elements of the PASN first frame to the second AP and the identifier of the client device that the client device is to use for wireless communications with the second AP are included in a data element for the PASN first frame.

7. The method of claim 6, wherein the indication that the first AP is to send the elements of the PASN first frame to the second AP is a Basic Service Set Identifier (BSSID) of the second AP that is identified in the data element and the identifier of the client device that the client device is to use for wireless communications with the second AP is a media access control (MAC) address that the client device is to use for wireless communications with the second AP in which the MAC address identified in the data element.

8. The method of claim 6, wherein the indication that the first AP is to send the elements of the PASN first frame to the second AP is a Basic Service Set Identifier (BSSID) of the second AP that is identified in 6 octets of the data element and the identifier of the client device that the client device is to use for wireless communications with the second AP is a media access control (MAC) address that the client device is to use for wireless communications with the second AP in which the MAC address is identified in another 6 octets of the data element.

9. The method of claim 1, further comprising:
encrypting the PASN first frame by the client device using a key of the client device provided to the first AP through establishing the first PASN session between the client device and the first AP.

10. The method of claim 1, wherein the PASN second frame obtained by the client device is encrypted using a key of the first AP provided to the client device through establishing the first PASN session between the client device and the first AP.

11. A method comprising:
establishing a first Pre-Association Security Negotiation (PASN) session between a first access point (AP) and a client device;
obtaining, by the first AP via the first PASN session, a PASN first frame from the client device, the PASN first frame comprising PASN first frame elements including a key of the client device, an indication that the first AP is to send the PASN first frame elements to a second AP, and an identifier of the client device that the client device is to use for wireless communications with the second AP;
transmitting, by the first AP, the PASN first frame elements to the second AP based on the indication included in the PASN first frame;
obtaining, by the first AP from the second AP, PASN second frame elements including a key of the second AP, a message integrity code (MIC) associated with the second AP, and a timeout value; and
transmitting a PASN second frame to the client device that includes the PASN second frame elements for establishing a second PASN session between the client device and the second AP.

12. The method of claim 11, wherein the indication that the first AP is to send the PASN first frame elements to the second AP and the identifier of the client device that the client device is to use for wireless communications with the second AP are included in a data element for the PASN first frame.

13. The method of claim 12, wherein the indication that the first AP is to send the PASN first frame elements to the second AP is a Basic Service Set Identifier (BSSID) of the second AP that is identified in the data element and the identifier of the client device that the client device is to use for wireless communications with the second AP is a media access control (MAC) address that the client device is to use for wireless communications with the second AP in which the MAC address identified in the data element.

14. The method of claim 11, further comprising:
encrypting, by the first AP, the PASN second frame using a key of the first AP provided to the client device through establishing the first PASN session between the first AP and the client device.

15. A method comprising:
establishing a first Pre-Association Security Negotiation (PASN) session between a client device and a first access point (AP) through initial PASN communications exchanged between the client device and the first AP; and
performing subsequent PASN communications between the client device and at least one other AP that are facilitated through the first PASN session established between the client device and the first AP to enable at least one subsequent PASN session to be established between the client device and the at least one other AP.

16. The method of claim 15, wherein performing the subsequent PASN communications includes obtaining, by the first AP, a first PASN frame that includes an indication that causes the first AP to identify the at least one other AP that is to be involved in the subsequent PASN communications.

17. The method of claim 16, wherein the indication is a Basic Service Set Identifier (BSSID) of the at least one other AP that is identified in the PASN first frame.

18. The method of claim 16, wherein the PASN first frame obtained by the first AP from the client device further includes an identifier of the client device that the client device is to use for wireless communications with the at least one other AP.

19. The method of claim 18, wherein the identifier of the client device that the client device is to use for wireless communications with the at least one other AP is a Media Access Control (MAC) address that the client device is to use for wireless communications with the at least one other AP.

20. The method of claim 15, wherein performing the subsequent PASN communications includes communicating a PASN second frame to the client device from the first AP that includes an ephemeral public key of the at least one other AP, a Message Integrity Code (MIC) associated with the at least one other AP, and a timeout value.
